(19) United States
(12) Patent Application Publication
(10) Pub. No.: US 2003/0131460 A1
(43) Pub. Date: Jul. 17, 2003

(54) Engine cylinder head elevator apparatus and method of use

(75) Inventors: Thomas Robert Burns, Clarkston, MI (US); Donald Harold Santhony, Garden City, MI (US)

Correspondence Address: Bill C. Panagos, Detroit Diesel Corporation, 13400 Outer Drive, West, Detroit, MI, 48239-4001, US

(73) Assignee: Detroit Diesel Corporation

(21) Appl. No.: 10/043,835

(22) Filed: Jan. 14, 2002

(51) Int. Cl. B23P 19/04

(52) U.S. Cl. 29/252

(57) ABSTRACT

A cylinder head elevator tool developed and constructed to expedite the replacement of cylinder head gaskets, pistons, connecting rods, liners or sleeves, intake valves, exhaust valves, and many other associated components in diesel engines. The cylinder head elevator includes a lower bracket or support bracket engageable with the diesel engine cylinder block, an upper bracket or cylinder head bracket, including a collar assembly, engageable with the cylinder head, and a hydraulic jack or hydraulic ram engageable at it's base with said lower bracket and engageable at its moveable shaft end with said upper bracket.

### BACKGROUND OF THE INVENTION

1. Field of the Invention

This invention relates to the field of diesel engine maintenance tools and, more particularly, to a tool for lifting the cylinder head of a diesel engine for the easy servicing of cylinder head gaskets, pistons, connecting rods, liners or sleeves, intake valves, exhaust valves, and many other associated components.

2. Description of the Related Art

Large diesel engines, such as the Detroit Diesel S-60 truck engine, because of its size and complexity, can present somewhat of a challenge in terms of normal maintenance. Occasionally, in the course of normal maintenance of such diesel engines, it is necessary to replace components such as cylinder head gaskets, pistons, connecting rods, liners or sleeves, intake valves, exhaust valves, and other associated components. Furthermore, one or more of these components may become damaged or worn out, thus necessitating replacement.

In order to service or replace such components it is necessary to raise the cylinder head of the engine. While there are a number of means of raising the cylinder head such as, for example, using a hoist or crane, or human strength. When the use of a hoist or crane is not possible do to the location or placement, or application, of the diesel engine a better and safer method than human strength is required.

Thus, there is a need for a simple, efficient, and relatively inexpensive device which presents a solution to the inability to use a hoist or crane due to location or application of the diesel engine as well as being safer than relying solely on human strength.

### SUMMARY OF THE INVENTION

Disclosed and claimed herein is a cylinder head elevator tool developed and constructed to expedite the replacement of cylinder head gaskets, pistons, connecting rods, liners or sleeves, intake valves, exhaust valves, and many other associated components in diesel engines. It includes a lower bracket or support bracket engageable with the diesel engine cylinder block, an upper bracket or cylinder head bracket, including a collar assembly, engageable with the cylinder head, and a hydraulic jack or hydraulic ram engageable at it's base with said lower bracket and engageable at is moveable shaft end with said upper bracket.

Preferably the lower bracket or support bracket is engaged with the cylinder block using existing bolt holes on the cylinder block and standard fasteners. Likewise, preferably the upper bracket or cylinder head bracket is engaged with the cylinder head using existing bolt holes on the cylinder head with standard fasteners.

A hydraulic jack or hydraulic ram is positioned between the lower and upper brackets. The hydraulic jack or hydraulic ram is of a standard design well known to those skilled in the art. Said hydraulic jack or hydraulic ram being engaged with the lower bracket using standard fasteners and being engaged with the upper bracket by means of a collar and standard fasteners. The hydraulic jack or ram further includes a means of raising and lowering said jack or ram. Said means preferably being manual.

One preferred embodiment comprises an engine cylinder head elevator apparatus for raising the cylinder head off of the engine block comprising, (a) a lower bracket having a first surface engageably mountable on the engine block and a second surface, substantially perpendicular to said first surface, for engageably mounting a hydraulic jack, (b) a hydraulic jack engageably mountable at its base to the top of the lower bracket second surface of (a), (c) an upper bracket having a first surface engageably mountable on the cylinder head and a second surface, substantially perpendicular to said first surface, for engageably mounting a collar assembly, (d) a collar assembly engageably mounted to the bottom of said second surface of (c) and further engageably mounted to the top of said hydraulic jack of (b), (e) a fastener means for engageably mounting said engine cylinder head elevator apparatus components together and to the engine block and cylinder head, wherein, upon activation of the hydraulic jack the cylinder head is raised and held substantially stationary a desired distance above the engine block, thereby allowing routine maintenance and repairs to be readily performed.

In practice the lower bracket is engaged with the cylinder block using standard fasteners. Then the upper bracket with the collar assembly is engaged with the cylinder head using standard fasteners. The hydraulic jack or ram base or bottom end is engaged with the lower bracket using standard fasteners and its upper or piston end is engaged with the upper bracket collar assembly and standard fasteners. After removing all necessary parts and cylinder head bolts the jack or ram is operated in normal known manner thus causing the cylinder head to raise up off of the cylinder block and the cylinder block can be serviced thus engaged and raised. The cylinder block components can be serviced while the apparatus of the invention maintains the cylinder head in a raised position. The cylinder head is then lowered back into position on the cylinder block by reversing this operation and removing the apparatus of the invention by reversing the mounting operation.

One preferred embodiment comprises raising a cylinder head above an engine block for service or repair comprising: engageably mounting a lower bracket to the engine block, engageably mounting the base of a hydraulic jack to said lower mounting bracket, engageably mounting an upper bracket to the top of said hydraulic jack, engageably mounting the upper bracket to the cylinder head, removing necessary parts and bolts from said cylinder head, activating said hydraulic jack thereby raising and holding said cylinder head above said engine block.

### BRIEF DESCRIPTION OF THE DRAWINGS

The following detailed description may best be understood by reference to the following drawings, in which:

FIG. 1 is a front plan view of the invention attached to a diesel engine preparatory to raising the cylinder head.

FIG. 2 is a front plan view of the invention attached to a diesel engine with the cylinder head raised.

### DESCRIPTION OF THE PREFERRED EMBODIMENTS OF THE INVENTION

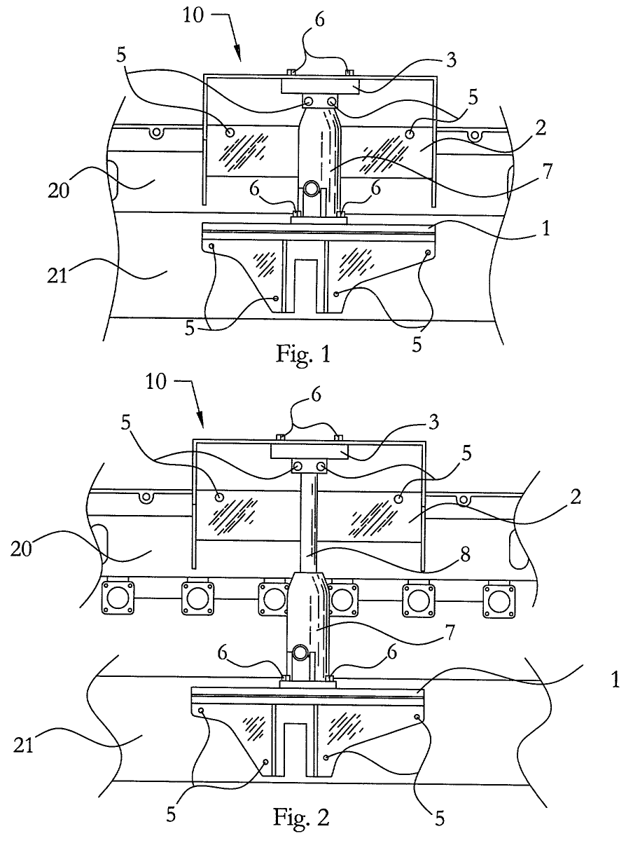

Throughout the following detailed description, like numerals are used to reference the same elements of the invention shown on multiple figures thereof. Referring now to the drawings, and in particular to FIGS. 1 and 2. FIG. 1 shows an engine cylinder head 20, in partial front view, mounted on an engine block 21, also shown in partial front view, with the invention 10 mounted thereon. More particularly, lower or support bracket 1 is engageably mounted on engine block 21 through bolt holes 5 utilizing standard fasteners (not shown) engaged in existing bolt holes (not shown) in engine block 21. The base of the hydraulic jack or ram 7 is then mounted to the top of the lower or support bracket 1 using standard fasteners 6 through bolt holes 5. The hydraulic jack or ram 7 is configured with its piston shaft 8 (FIG. 2) in fully retracted, or lowest, position (see FIG. 1). The upper or cylinder head bracket 2 is attached to the top of the hydraulic jack or ram 7 piston shaft 8 (FIG. 2) by collar 3 utilizing standard fasteners 6 through bolt holes 5. The upper or cylinder head bracket 2 is then engageably mounted on cylinder head 20 through bolt holes 5 utilizing standard fasteners (not shown) engaged in existing bolt holes (not shown) in cylinder head 20.

In practice the necessary parts and cylinder head bolts are removed from the cylinder head. The hydraulic jack or ram 7 is then operated in known manner to extend the piston shaft 8 (FIG. 2) thereby raising the cylinder head 20 off of and above the engine block 21 (shown in FIG. 2).

The engine can now be serviced in known fashion with the cylinder head 20 and engine block 21 separated while safely mounted on the invention 10.

It is to be understood that the shape and size of the brackets of the claimed invention, as well as the number and position of the bolt holes, may be changed to adapt to a particular engine and cylinder block. The materials used and construction methods employed are standard materials and construction methods well known to those skilled in the art. Furthermore, the hydraulic jack or ram size and lifting capacity can be selected to suit the particular engine and such selection is well known in the art. All of these adaptations may be made in known manner within the scope of the present invention. Moreover, the present invention is simple to assemble and also to use. It provides a safe, convenient and quick way of lifting the cylinder head of diesel engines so that routine maintenance or repairs may be readily performed thereon.

The foregoing description, drawings, and examples are of a preferred embodiment of the present invention and are not to be read as limiting the invention. The scope of the invention should be construed by reference to the following claims.

What is Claimed is:

1. An engine cylinder head elevator apparatus for raising the cylinder head off of the engine block comprising:
a. a lower bracket having a first surface engageably mountable on the engine block and a second surface, substantially perpendicular to said first surface, for engageably mounting a hydraulic jack;
b. a hydraulic jack engageably mountable at its base to the top of the lower bracket second surface of (a),
c. an upper bracket having a first surface engageably mountable on the cylinder head and a second surface, substantially perpendicular to said first surface, for engageably mounting a collar assembly,
d. a collar assembly engageably mounted to the bottom of said second surface of (c) and further engageably mounted to the top of said hydraulic jack of (b),
e. a fastener means for engageably mounting said engine cylinder head elevator apparatus components together and to the engine block and cylinder head,
wherein, upon activation of the hydraulic jack the cylinder head is raised and held substantially stationary a desired distance above the engine block, thereby allowing routine maintenance and repairs to be readily performed.

2. The engine cylinder head elevator apparatus as claimed in claim 1 wherein, each said fastener means comprises a standard bolt for insertion into each of said bolt holes.

3. The engine cylinder head elevator apparatus as claimed in claim 1 wherein, said apparatus is engageably mounted to said cylinder head and said engine block utilizing existing mounting bolt holes in said cylinder head and said engine block.

4. A method of raising a cylinder head above an engine block for service or repair comprising: engageably mounting a lower bracket to the engine block, engageably mounting the base of a hydraulic jack to said lower mounting bracket, engageably mounting an upper bracket to the top of said hydraulic jack, engageably mounting the upper bracket to the cylinder head, removing necessary parts and bolts from said cylinder head, activating said hydraulic jack thereby raising and holding said cylinder head above said engine block.
